(19) United States
(12) Patent Application Publication
(10) Pub. No.: US 2001/0051978 A1
(43) Pub. Date: Dec. 13, 2001

(54) METHOD AND APPARATUS FOR PROVIDING A PERSONALIZATION SERVICE ACROSS A NETWORK

(76) Inventors: BRADLEY P. ALLEN, MANHATTAN BEACH, CA (US); JOHN B. JENSEN, HERMOSA BEACH, CA (US); JEFFREY M. GREIF, VENICE, CA (US); LAWRENCE POYNTER, MARINA DEL REY, CA (US)

Correspondence Address: PARK, VAUGHAN & FLEMING LLP, 508 SECOND STREET, SUITE 201, DAVIS, CA, 95616, US

(21) Appl. No.: 09/417,953

(22) Filed: Oct. 13, 1999

(51) Int. Cl. G06F 15/16

(52) U.S. Cl. 709/203; 709/217; 709/229

(57) ABSTRACT

One embodiment of the present invention provides a system for producing personalized web site content to be presented to a user of a content provider web site based upon information gathered regarding the user. The system operates by receiving data sent from a remote browser to a personalization server. This data is sent by a web page on the remote browser and includes an identifier for the user. This web page was previously sent from the content provider web site to the remote browser while the remote browser was navigating through the content provider web site. The personalization server uses the identifier to look up information related to the user in a database associated with the personalization server. This information is used to produce personalized web site content for the user based upon the interests of the user. For example, personalized web site content can include hypertext markup language (HTML) code, images or navigational options to other web locations. Next, the system sends personalized web site content from the personalization server to the remote browser so that the personalized web site content can be presented to the user.

### BACKGROUND

1. Field of the Invention

The present invention relates to personalization of web sites on the Internet. More particularly, the present invention relates to a method and an apparatus for providing a personalization service that facilitates making recommendations regarding options to be presented to a user of web site based upon information associated with the user.

2. Related Art

The tremendous growth of electronic commerce has led to an explosion in the number of web sites offering products and services for sale. Unlike conventional methods for propagating sales messages, which typically rely on mass media to distribute a uniform message to thousands or millions of consumers, electronic commerce makes it possible to tailor the presentation of a message on a web site to the individual tastes of a specific consumer based upon information previously gathered about the consumer.

To this end, web sites have been “personalized” so that the interests displayed by a consumer in clicking through various regions of a web site and other demographic information provided by the consumer can be used to predict the interests of the consumer. These predicted interests are used to tailor the presentation of a sales message to an individual consumer in order to maximize the probability of a sale. These predicted interests can also be used to filter out material that is not of interest to the consumer.

Unfortunately, providing such personalization can be a time-consuming and expensive proposition. The owner of the web site must typically purchase an expensive enterprise-level system to make the predictions concerning consumer interests that form the basis of personalization. This may require purchasing additional computer hardware to store consumer preferences and to predict consumer interests. Furthermore, this enterprise-level system must be integrated into the web site, which can consume many hours of time in programming and testing.

What is needed is a method and an apparatus that provides personalization to a web site without the time and expense involved in purchasing and integrating an enterprise level prediction system into the web site.

Some existing systems provide targeted adds to consumers. Such a system is described in “Method of Delivery, Targeting and Measuring Advertising Over Networks,” U.S. Pat. No. 5,948,061 issued Sep. 7, 1999 to Merriman, et al. In this type of system, a content provider web site displays advertisements from a seller to consumers who are navigating through the content provider's web site. If a consumer responds to the advertising message, the content provider receives a payment from the seller.

Although this type of advertising message can be somewhat customized for a particular user, the customization affects only the type of advertisement from a third party advertiser that is displayed. This customization does not to “personalize” the presentation of the content provider's web site or the navigational options within the content provider's web site.

### SUMMARY

One embodiment of the present invention provides a system for producing recommendations regarding web-related navigational options to be presented to a user of a content provider web site based upon information gathered regarding the user. The system operates by receiving data sent from a remote browser to a personalization server. This data is sent by a web page on the remote browser and includes an identifier for the user. This web page was previously sent from the content provider web site to the remote browser while the remote browser was navigating through the content provider web site. The personalization server uses the identifier to look up information related to the user in a database associated with the personalization server. This information is used to predict a set of recommendations that the user may be interested in. For example, a set of recommendations can specify web-related navigational options for the user. Next, the system sends the set of recommendations from the personalization server to the remote browser so that the set of recommendations can be presented to the user, whereby the user is able to select a recommendation from the set of recommendations.

In one embodiment of the present invention, the system receives the recommendation selected by the user from the remote browser, and uses the recommendation to lookup a target web location associated with the recommendation. The system then directs the remote browser to the target web location.

In one embodiment of the present invention, the target web location is located within the content provider web site. In another embodiment of the present invention, the target web location is located on a web site belonging to an affiliate of an owner of the content provider web site.

In one embodiment of the present invention, the system receives information regarding the user from the remote browser at the personalization server. This information is sent by a second web page from a second content provider's web site and includes the identifier for the user and additional information about the user. The system stores the additional information about the user in the database so that the additional information can be used by the personalization server to make recommendations that more accurately reflect the user's interests.

In one embodiment of the present invention, the database includes information that is entered into web pages by the user from a number of different web sites visited by the user.

In one embodiment of the present invention, the identifier for the user includes a cookie.

In one embodiment of the present invention, the web page originating from the content provider web site includes HyperText Markup Language (HTML) that causes the remote browser to communicate the data to the personalization server.

In one embodiment of the present invention, the data received from the remote browser includes an identifier for the content provider web site and an identifier for the web page within the content provider web site.

In one embodiment of the present invention, the data received from the remote browser contains information regarding the user.

In one embodiment of the present invention, the system charges an owner of the content provider web site a fee for making use of the set of recommendations received from the personalization server. In a variation on this embodiment, the fee is function of a volume of usage of the personalization server by browsers communicating with the content provider web site.

In one embodiment of the present invention, the system predicts the set of recommendations using an on-line predictive memory.

In one embodiment of the present invention, the system predicts the set of recommendations using a prediction engine that makes predictions based upon preferences of similar users.

One embodiment of the present invention provides a system that produces recommendations regarding web-related navigational options to be presented to a user of a content provider web site based upon information gathered regarding the user. The system operates by providing a content provider with code that the content provider includes in web pages within the content provider's web site. This code causes a remote browser accessing the web pages to communicate information regarding the user of the remote browser to the personalization server. The system receives the information regarding the user of the remote browser at the personalization server, and stores the information in a database associated with the personalization server.

The system also provides the content provider with other code that the content provider includes in web pages within the content provider web site. This other code causes a remote browser accessing the web pages to request personalized links from the personalization server. Upon receiving a request for personalized links from the remote browser, the personalization server uses an identifier in the request to look up information related to the user in the database associated with the personalization server. The system uses the information to produce a set of personalized links that the user may be interested in. The system sends the set of personalized links from the personalization server to the remote browser so that the set of personalized links can be presented to the user. This allows the user to select a link from the set of personalized links. Finally, the system charges an owner of the content provider web site a fee for sending the set of personalized links from the personalization server to the remote browser.

One embodiment of the present invention provides a system for producing personalized web site content to be presented to a user of a content provider web site based upon information gathered regarding the user. The system operates by receiving data sent from a remote browser to a personalization server. This data is sent by a web page on the remote browser and includes an identifier for the user. This web page was previously sent from the content provider web site to the remote browser while the remote browser was navigating through the content provider web site. The personalization server uses the identifier to look up information related to the user in a database associated with the personalization server. This information is used to produce personalized web site content for the user based upon the interests of the user. For example, personalized web site content can include hypertext markup language (HTML) code, images or navigational options to other web locations. Next, the system sends personalized web site content from the personalization server to the remote browser so that the personalized web site content can be presented to the user.

### BRIEF DESCRIPTION OF THE FIGURES

FIG. 1 illustrates a networked computer system in accordance with an embodiment of the present invention.

FIG. 2 illustrates the internal structure of a personalization server in accordance with an embodiment of the present invention.

FIG. 3 is a flow chart illustrating the process of operating a personalization server in accordance with an embodiment of the present invention.

FIG. 4 is a flow chart illustrating the process of providing a personalization service in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

### Networked Computer System

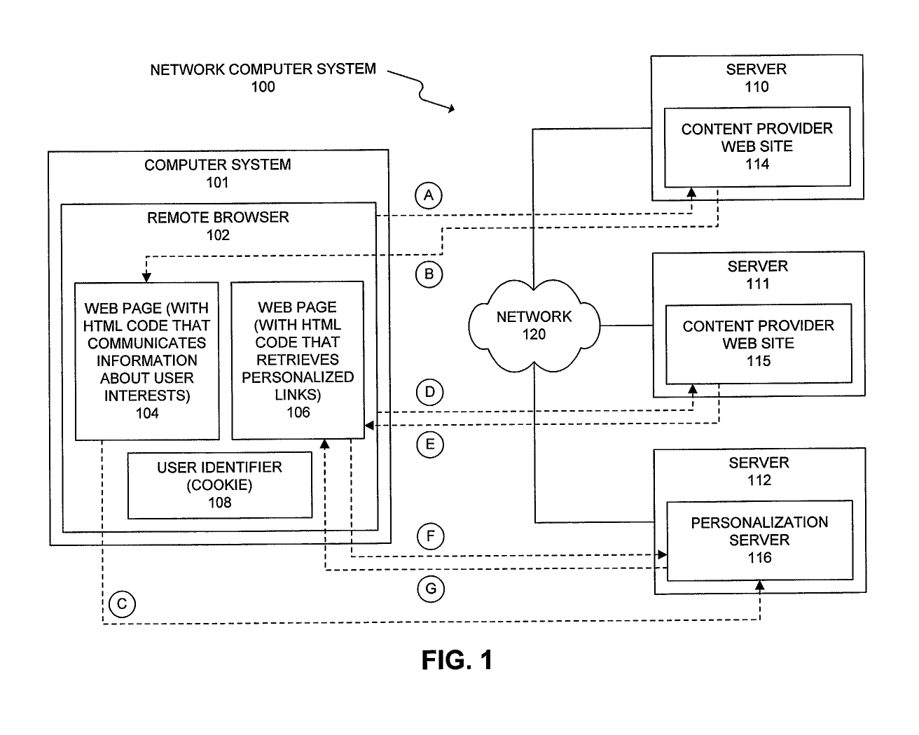

FIG. 1 illustrates networked computer system 100 in accordance with an embodiment of the present invention. Networked computer system 100 includes computer system 101 and servers 110-112, which are coupled together through network 120. Computer system 101 can include any type of computer system that can support a browser, such as remote browser 102. This includes, but is not limited to, a computer system based upon a microprocessor, a mainframe processor, a device controller, and a computational engines within an appliance. Network 120 can include any type of wire or wireless communication channel capable of coupling together computer system 101 and servers 110-112. This includes, but is not limited to, a local area network, a wide area network, or a combination of networks. In one embodiment of the present invention, network 120 includes the Internet.

Servers 110-112 can include any nodes on a computer network including a mechanism for servicing requests from a client for computational and/or data storage resources. More specifically, servers 110-111 function as hosts for content provider web sites 114 and 115, respectively. Server 112 functions as a host for personalization server 116.

Content provider web sites 114 and 115 can include any type of web site that can make use of personalization server 116 in order to personalize the presentation of content provider web sites 114 and 115. To this end, content provider web sites 114 and 115 can include any type of web sites that present information and/or sell goods and services.

In general, personalization refers to the process of tailoring a presentation of a web site for a user of the web site. For example, if a user expresses an interest in golf, the web site presentation can be tailored to display golf-related equipment and services to the user. This personalization process can influence the images that are displayed to the user on various web pages. It can also influence the type of links that are presented to a user to navigate between web pages on the web site. For example, a golfing enthusiast may be presented with links that are related to golfing products and services.

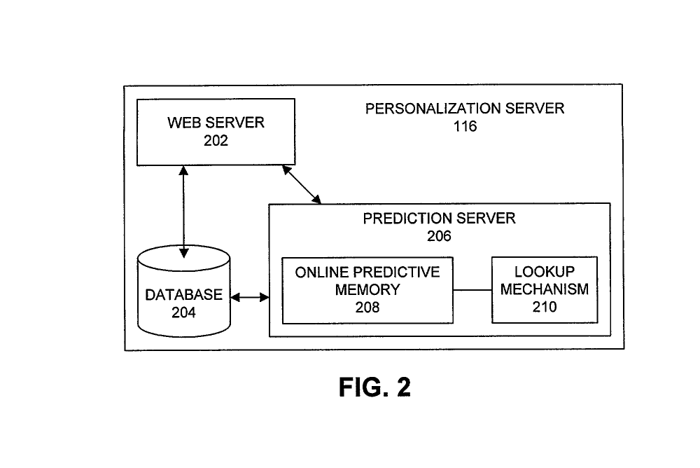

Personalization server 116 within server 112 can include any type of server that can provide personalization for content provider web sites 114-115. The internal structure of personalization server 116 is described in more detail below with reference to FIGS. 2-4.

Computer system 101 includes remote browser 102. Remote browser 102 can include any type of browser for viewing web pages supplied by content provider web sites 114-115. For example, remote browser 102 can include a version of the Internet Explorer browser produced by the Microsoft Corporation of Redmond, Washington. Remote browser 102 can contain a number of web pages loaded from content provide web sites 114-115. More specifically, web page 104 is loaded from content provider web site 114 and web page 106 is loaded from content provider web site 115.

Web page 104 includes HyperText Markup Language (HTML) code that causes remote browser 102 to communicate information on user interests to personalization server 116 in server 112. This information on user interests can include, the types of pages that the user has seen, the types of personalized links the user has followed, demographic information on the user and an indication that a particular recommendation was accepted by the user.

Web page 106 includes HTML code that causes remote browser 102 to retrieve personalized links from personalization server 116. Remote browser 102 additionally includes an identifier 108, which identifies a user of remote browser 102 to personalization server 116. In one embodiment of the present invention, identifier 108 includes a “cookie.” A cookie is a data item that contains an identity of a user that is automatically provided to web sites accessed by the browser. In general, a cookie can contain other information about the user.

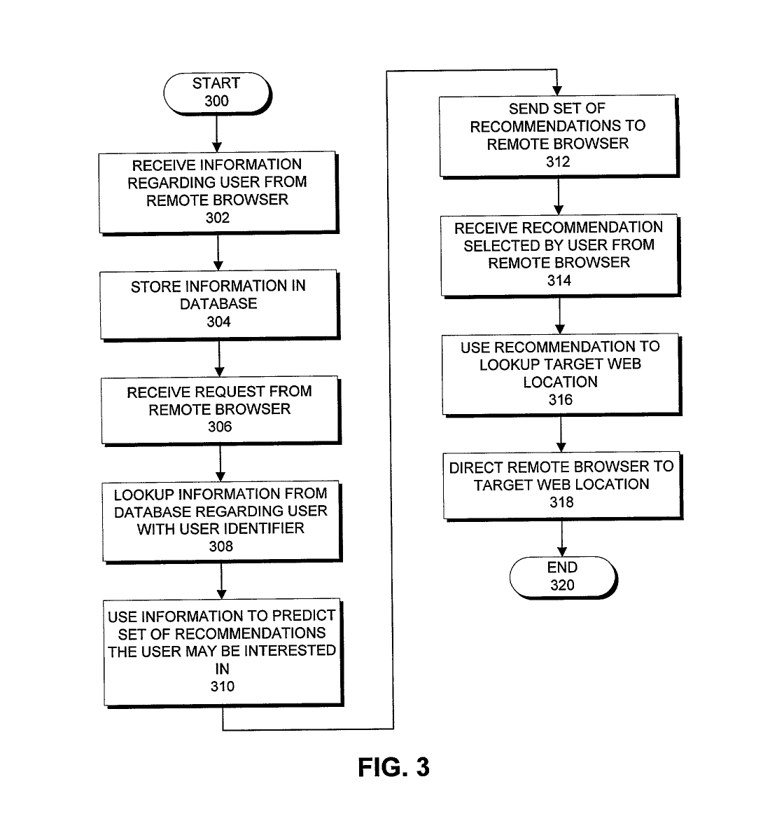

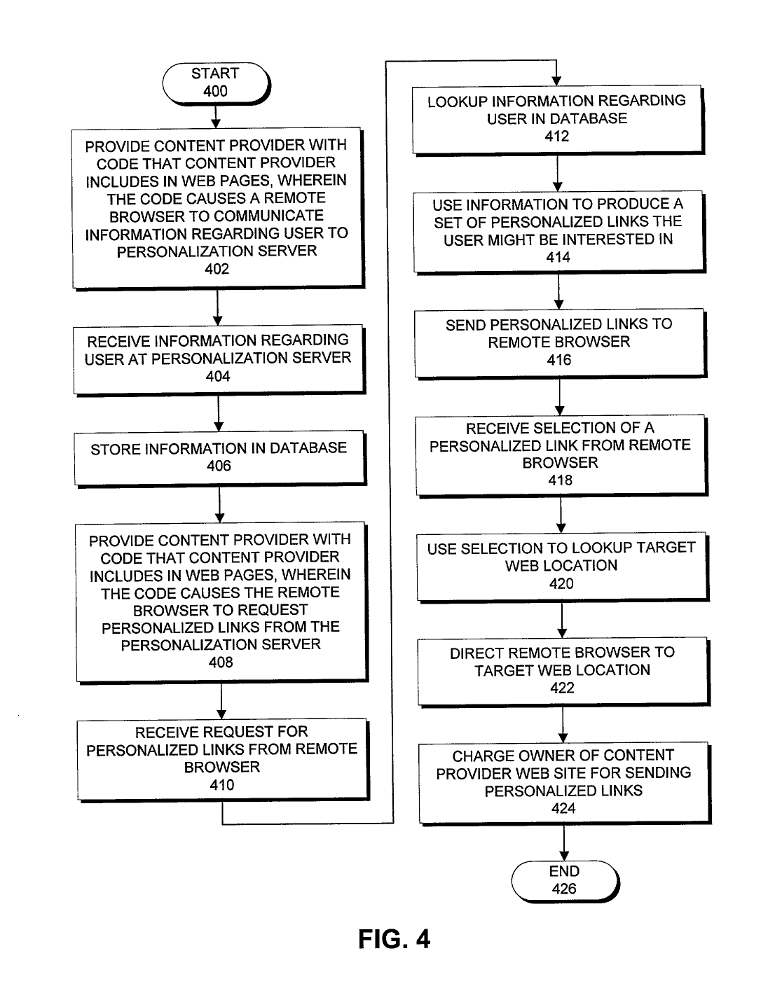

Interactions between remote browser 102, content provider web sites 114-115 and personalization server 116 are described in more detail below with reference to FIGS. 3 and 4.

### Personalization Server

FIG. 2 illustrates the internal structure of a personalization server 116 in accordance with an embodiment of the present invention. Personalization server 116 includes web server 202, database 204 and prediction server 206. Web server 202 generally handles communications between personalization server 116 and remote browsers, such a remote browser 102.

Database 204 contains information on users of browsers that communicate with personalization server 116. As discussed above, this information can include user interests as well as demographic information for the user gathered by various web sites. Note that web sites gather the information by loading web pages into remote browsers. These web pages cause the remote browsers to forward the information to personalization server 116. This can be accomplished by placing an image tag inside of a HyperText Markup Language (HTML) specification for a web page that causes the information to be sent to personalization server 116. However, note that any other mechanism that causes the information to be sent to personalization server 116 can be used.

In another embodiment of the present invention, the web sites send the information to personalization server 116 directly.

Prediction server 206 can include any mechanism that is able to make predictions about preferences of a user from data retrieved from database 204 regarding the user. In the embodiment illustrated in FIG. 2, prediction server 206 includes online predictive memory 208 as well as lookup mechanism 210. Lookup mechanism 210 facilitates looking up user preferences within online predictive memory 208. Online predictive memory 208 is a prediction mechanism that adapts dynamically to new data as new data is received.

The operation of online predictive memory 208 is described in more detail in U.S. patent application Ser. No. 09/054,178, entitled “Online Predictive Memory,” by inventors Bradley P. Allen, et al. filed on Apr. 2, 1998. The above-specified application is hereby incorporated by reference in order to disclose the workings of an online predictive memory.

### Process of Operating a Personalization Server

FIG. 3 is a flow chart illustrating the process of operating personalization server 116 in accordance with an embodiment of the present invention. The system starts by receiving information regarding a user from remote browser 102 at personalization server 116 (step 302). As mentioned above, this information can include the types of pages the user has seen, the types of links the user has followed and demographic information about the user. The information also includes user identifier 108, which uniquely identifies the user. Personalization server 116 stores this information in database 204 (step 304) so that the information can be indexed by user identifier 108. Note that data for a particular user can be gathered by pages sent to remote browser 102 from different web sites that remote browser 102 navigates through.

Next, personalization server 116 receives a request for personalized information from remote browser 102 (step 306). This request includes user identifier 108. Personalization server 116 uses user identifier 108 to lookup information about the user from database 204 (step 308). This information is combined with contextual information (such as the current web page that is presently being viewed by the user) and is used to produce a set of personalized recommendations to be presented to the user (step 310). Personalization server 116 does this by using online predictive memory 208 to produce the set of recommendations. These recommendations are generally based upon what users with similar information have been interested in. In general, any type of prediction mechanism or classifier can be used in place of online predictive memory 208. Also note that the set of recommendations can include navigational options (web links) for the user to follow. The set of recommendations is then sent to remote browser 102 (step 312).

Next, personalization server 116 receives a recommendation selected by the user from remote browser 102 (step 314). Personalization server 116 uses the selection to lookup a target web location associated with the selection (step 316). Next, personalization server 116 directs remote browser 102 to the target web location (step 318). In another embodiment of the present invention, personalization server 116 simply sends a set of target web locations to remote browser 102, and the user selects one of the target web locations without having the communicate with personalization server 116 again.

Note that the target web location can reside within the same website that remote browser 102 is navigating through. In this way, personalization server 116 can be used to personalize a web site, such as content provider web sites 114-115.

The target web site can also include a location within an affiliate web site. Affiliate web sites are generally different web sites belonging to affiliate. Affiliate web sites may be separately owned web sites, separately maintained and organized web sites, web sites distributed across the Internet or any other wide area or local area network, such as a corporate intranet, web sites on separate physical servers, web sites with distinct Internet Protocol (IP addresses), web sites with different IP domains, web sites with different port numbers. Affiliate web sites can also include web sites owned by a single business entity, but separately hosted, maintained and/or organized. Affiliate web sites can additionally include web sites within the same Internet portal, but separately maintained and organized; for example, an “online shopping mall.”

### Process of Providing a Personalization Service

FIG. 4 is a flow chart illustrating the process of providing a personalization service in accordance with an embodiment of the present invention. First, the owner of content provider web site 114 is provided with code in HyperText Markup Language (HTML) form that the owner includes in web pages on content provider web site 114 (step 402). Next, suppose remote browser 102 is navigating through content provider web site 114. Remote browser 102 requests a web page 104 from content provider web site 114(A), and content provider web site 114 sends web page 104 to remote browser 102(B). Web page 104 includes HTML code that causes remote browser 102 to communicate information regarding user interests to personalization server 116(C). Personalization server 116 then receives the information on the user interests (step 404), and stores the information in database 204 (step 406).

Next, a content provider, such as the owner of content provider web site 115 is provided with code in HyperText Markup Language (HTML) form that the owner includes in web pages on content provider web site 115 (step 408). This HTML code causes a browser to request personalized links from personalization server 116. Next, suppose remote browser 102 is navigating through content provider web site 115. Remote browser 102 requests web page 106 from content provider web site 115(D), and content provider web site 115 sends web page 106 to remote browser 102(E). Web page 106 causes remote browser 102 to request personalized links from personalization server 116(F). Next, personalization server 116 receives the request (step 410). This request includes a user identifier 108 that personalization server 116 uses to lookup information related to the user in database 204 (step 412). Personalization server 116 uses this information to produce a set of personalized links that the user may be interested in (step 414). Next, the set of personalized links is sent to remote browser 102 to be displayed to the user (step 416) (G). This allows the user to select a personalized link. Personalization server 116 next receives the selection of the personalized link from remote browser 102 (step 418), and uses the selection to lookup a target web location associated with the selection (step 420). Personalization server 116 then directs remote browser 102 to the target web location (step 422).

Next, the owner the content provider web site 115 is charged a fee for using personalization server 116 (step 424). This fee can be a function of a volume of usage, or any other type of fee arrangement such as a flat fee. A volume-based fee allows an owner of a web site to invest a minimal amount in up front costs in order to personalize the web site. Expense is only incurred as the personalization service is used.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

What is claimed is:

1. A method for providing recommendations regarding web-related navigational options to be presented to a user of a content provider web site based upon information gathered regarding the user, comprising:
receiving data from a remote browser at a personalization server, the data including an identifier for the user;
wherein the data is sent by a web page on the remote browser, the web page being sent from the content provider web site to the remote browser when the content provider web site is viewed through the remote browser;
using the identifier to look up information related to the user in a database associated with the personalization server;
using the information to predict a set of recommendations that the user may be interested in, the set of recommendations specifying web-related navigational options for the user; and
sending the set of recommendations from the personalization server to the remote browser so that the set of recommendations can be presented to the user, whereby the user is able to select a recommendation from the set of recommendations.

2. The method of claim 1, further comprising
receiving the recommendation selected by the user from the remote browser;
using the recommendation selected by the user to lookup a target web location associated with the recommendation; and
directing the remote browser to the target web location.

3. The method of claim 2, wherein the target web location is located on the content provider web site.

4. The method of claim 2, wherein the target web location is located on a web site belonging to an affiliate of an owner of the content provider web site.

5. The method of claim 1, further comprising:
receiving information regarding the user from the remote browser at the personalization server, the information being sent by a second web page from a second content provider web site, the information including the identifier for the user and additional information about the user; and
storing the additional information about the user in the database associated the personalization server;
whereby the additional information can be used by the personalization server to make recommendations that more accurately reflect the user's interests.

6. The method of claim 1, wherein the database includes information that is entered into web pages by the user from a number of different web sites visited by the user.

7. The method of claim 1, wherein the identifier for the user includes a cookie.

8. The method of claim 1, wherein the web page originating from the content provider web site includes HyperText Markup Language (HTML) that causes the remote browser to communicate the data to the personalization server.

9. The method of claim 1, wherein the data received from the remote browser includes an identifier for the content provider web site and an identifier for the web page within the content provider web site.

10. The method of claim 1, wherein the data received from the remote browser contains information regarding the user.

11. The method of claim 1, further comprising charging an owner of the content provider web site a fee for making use of the set of recommendations received from the personalization server.

12. The method of claim 11, wherein the fee is function of a volume of usage of the personalization server by browsers communicating with the content provider web site.

13. The method of claim 1, wherein using the information to predict the set of recommendations includes using an on-line predictive memory to predict the set of recommendations.

14. The method of claim 1, wherein using the information to predict the set of recommendations includes using a prediction engine that makes predictions based upon preferences of similar users.

15. A method for providing recommendations regarding web-related navigational options to be presented to a user of a content provider web site based upon information gathered regarding the user, comprising:
receiving data from a remote browser at a personalization server, the data including an identifier for the user;
wherein the data is sent by a web page on the remote browser, the web page being sent from the content provider web site to the remote browser when the content provider web site is viewed through the remote browser;
using the identifier to look up information related to the user in a database associated with the personalization server;
using the information to predict a set of recommendations that the user may be interested in, the set of recommendations specifying web-related navigational options for the user;
sending the set of recommendations from the personalization server to the remote browser so that the set of recommendations can be presented to the user, whereby the user is able to select a recommendation from the set of recommendations;
receiving the recommendation selected by the user from the remote browser;
using the recommendation selected by the user to lookup a target web location associated with the recommendation; and
directing the remote browser to the target web location;
wherein the database includes information that is entered into web pages by the user from a number of different web sites visited by the user.

16. The method of claim 15, wherein the target web location is located on the content provider web site.

17. The method of claim 15, wherein the target web location is located on a web site belonging to an affiliate of an owner of the content provider web site.

18. The method of claim 15, further comprising:
receiving information regarding the user from the remote browser at the personalization server, the information being sent by a second web page from a second content provider web site, the information including the identifier for the user and additional information about the user; and
storing the additional information about the user in the database associated the personalization server;
whereby the additional information can be used by the personalization server to make recommendations that more accurately reflect the user's interests.

19. A computer-readable storage medium storing instructions that when executed by a computer cause the computer to perform a method for providing recommendations regarding web-related navigational options to be presented to a user of a content provider web site based upon information gathered regarding the user, comprising:
receiving data from a remote browser at a personalization server, the data including an identifier for the user;
wherein the data is sent by a web page on the remote browser, the web page being sent from the content provider web site to the remote browser when the content provider web site is viewed through the remote browser;
using the identifier to look up information related to the user in a database associated with the personalization server;
using the information to predict a set of recommendations that the user may be interested in, the set of recommendations specifying web-related navigational options for the user; and
sending the set of recommendations from the personalization server to the remote browser so that the set of recommendations can be presented to the user, whereby the user is able to select a recommendation from the set of recommendations.

20. The computer-readable storage medium of claim 19, wherein the method further comprises:
receiving the recommendation selected by the user from the remote browser;
using the recommendation selected by the user to lookup a target web location associated with the recommendation; and
directing the remote browser to the target web location.

21. The computer-readable storage medium of claim 20, wherein the target web location is located on the content provider web site.

22. The computer-readable storage medium of claim 20, wherein the target web location is located on a web site belonging to an affiliate of an owner of the content provider web site.

23. The computer-readable storage medium of claim 19, wherein the method further comprises:
receiving information regarding the user from the remote browser at the personalization server, the information being sent by a second web page from a second content provider web site, the information including the identifier for the user and additional information about the user; and
storing the additional information about the user in the database associated the personalization server;
whereby the additional information can be used by the personalization server to make recommendations that more accurately reflect the user's interests.

24. An apparatus that provides recommendations regarding web-related navigational options to be presented to a user of a content provider web site based upon information gathered regarding the user, comprising:
a receiving mechanism that receives data from a remote browser at a personalization server, the data including an identifier for the user;
wherein the data is sent by a web page on the remote browser, the web page being sent from the content provider web site to the remote browser when the content provider web site is viewed through the remote browser;
a lookup mechanism that uses the identifier to look up information related to the user in a database associated with the personalization server;
a prediction mechanism that uses the information to predict a set of recommendations that the user may be interested in, the set of recommendations specifying web-related navigational options for the user; and
a sending mechanism that sends the set of recommendations from the personalization server to the remote browser so that the set of recommendations can be presented to the user, whereby the user is able to select a recommendation from the set of recommendations.

25. The apparatus of claim 24,
wherein the receiving mechanism is further configured to receive the recommendation selected by the user from the remote browser;
wherein the lookup mechanism is further configured to use the recommendation selected by the user to lookup a target web location associated with the recommendation; and
wherein the sending mechanism is further configured to send the target web location to the remote browser so that the remote browser may be directed to the target web location.

26. The apparatus of claim 25, wherein the target web location is located on the content provider web site.

27. The apparatus of claim 25, wherein the target web location is located on a web site belonging to an affiliate of an owner of the content provider web site.

28. The apparatus of claim 24,
wherein the receiving mechanism is further configured to receive information regarding the user from the remote browser at the personalization server, the information being sent by a second web page from a second content provider web site, the information including the identifier for the user and additional information about the user; and
further comprising a storage mechanism that stores the additional information about the user in the database associated the personalization server;
whereby the additional information can be used by the personalization server to make recommendations that more accurately reflect the user's interests.

29. The apparatus of claim 24, wherein:
the database includes information that is entered into web pages by the user from a number of different web sites visited by the user.

30. The apparatus of claim 29, wherein the identifier for the user includes a cookie.

31. The apparatus of claim 24, wherein the web page from the content provider web site includes HyperText Markup Language (HTML) that causes the remote browser to communicate the data to the personalization server.

32. The apparatus of claim 24, wherein the data received from the remote browser includes an identifier for the content provider web site and an identifier for the web page within the content provider web site.

33. The apparatus of claim 24, wherein the data received from the remote browser contains information regarding the user.

34. The apparatus of claim 24, further comprising a charging mechanism that facilitates charging an owner of the content provider web site a fee for making use of the set of recommendations received from the personalization server.

35. The apparatus of claim 34, wherein the fee is function of a volume of usage of the personalization server by browsers communicating with the content provider web site.

36. The apparatus of claim 24, further comprising an on-line predictive memory that uses the information to predict the set of recommendations.

37. The apparatus of claim 24, further comprising a prediction engine that predicts the set of recommendations based upon preferences of similar users.

38. A method for providing a personalization server that produces recommendations regarding web-related navigational options to be presented to a user of a content provider web site based upon information gathered regarding the user, comprising:
providing a content provider with code that the content provider includes in web pages within the content provider web site, the code causing a remote browser accessing the web pages to communicate information regarding the user of the remote browser to the personalization server;
receiving the information regarding the user of the remote browser at the personalization server;
storing the information in a database associated with the personalization server;
providing the content provider with code that the content provider includes in web pages within the content provider web site, the code causing a remote browser accessing the web pages to request personalized links from the personalization server;
receiving a request for personalized links from the remote browser at the personalization server, the request including an identifier for the user;
using the identifier to look up information related to the user in the database associated with the personalization server;
using the information to produce a set of personalized links that the user may be interested in;
sending the set of personalized links from the personalization server to the remote browser so that the set of personalized links can be presented to the user, whereby the user is able to select a link from the set of personalized links; and
charging an owner of the content provider web site a fee for sending the set of personalized links from the personalization server to the remote browser.

39. The method of claim 38, further comprising
receiving a selection of a personalized link from the remote browser, the personalized link having been selected by the user from the set of personalized links;
using the selection to lookup a target web location associated with the personalized link; and
directing the remote browser to the target web location.

40. The method of claim 39, wherein the target web location is located on the content provider web site.

41. The method of claim 39, wherein the target web location is located on a web site belonging to an affiliate of the owner of the content provider web site.

42. The method of claim 38, wherein the data base includes information that is entered into web pages by the user from a number of different web sites visited by the user.

43. The method of claim 38, wherein the code that the content provider includes in the web pages includes HyperText Markup Language (HTML) code.

44. The method of claim 38, wherein the fee is function of a volume of usage of the personalization server by remote browsers communicating with the content provider web site.

45. The method of claim 38, wherein using the information to produce the set of personalized links includes using an on-line predictive memory to produce the set of personalized links.

46. The method of claim 38, wherein using the information to produce the set of personalized links includes using a prediction engine that selects the set of personalized links based upon preferences of similar users.

47. A method for providing personalized web site content to be presented to a user of a content provider web site based upon information gathered regarding the user, comprising:
receiving data from a remote browser at a personalization server, the data including an identifier for the user;
wherein the data is sent by a web page on the remote browser, the web page being sent from the content provider web site to the remote browser when the content provider web site is viewed through the remote browser;
using the identifier to look up information related to the user in a database associated with the personalization server;
using the information to produce personalized web site content for the user based upon the interests of the user; and
sending the personalized web site content from the personalization server to the remote browser so that the personalized web site content can be presented to the user.

48. The method of claim 47, wherein the personalized web site content includes HTML code.

49. The method of claim 47, wherein the personalized web site content includes images.

50. The method of claim 47, wherein the database includes information that is entered into web pages by the user from a number of different web sites visited by the user.

51. The method of claim 47, wherein the web page originating from the content provider web site includes HyperText Markup Language (HTML) that causes the remote browser to communicate the data to the personalization server.

52. The method of claim 47, further comprising charging an owner of the content provider web site a fee for making use of the personalized web site content received from the personalization server.

53. The method of claim 47, wherein using the information to produce the personalized web site content includes using an on-line predictive memory to select the personalized web site content.

54. The method of claim 47, wherein using the information to produce the personalized web site content includes using a prediction engine to select web site content based upon preferences of similar users.
